(19) United States
(12) Patent Application Publication
(10) Pub. No.: US 2016/0271760 A1
(43) Pub. Date: Sep. 22, 2016

(54) Multifunction Wrench Socket with Easily Recognizable Size Indicas

(71) Applicant: Bobby Hu, Taichung (TW)

(72) Inventor: Bobby Hu, Taichung (TW)

(21) Appl. No.: 14/702,798

(22) Filed: May 4, 2015

(30) Foreign Application Priority Data
Mar. 19, 2015 (TW) 104108744

(51) Int. Cl. B25B 13/06; B25B 13/46

(52) U.S. Cl. CPC B25B 13/06; B25B 13/462

(57) ABSTRACT

A wrench socket includes a first end having a polygonal hole and a second end. A driving portion includes an inner driving portion defined in the second end. The driving portion further includes an outer driving portion on an outer periphery of the second end. The outer driving portion includes six abutment faces arranged in a circumferential direction about a rotational axis. A first indicia is recessed in each of three of the six abutment faces not contiguous to each other. Each first indicia indicates a size of the polygonal hole. A wrench socket set including wrench sockets of different sizes is provided.

### BACKGROUND

The present invention relates to a wrench socket and, more particularly, to a multifunction wrench socket with easily recognizable size indicias.

Wrench sockets are a tool that can be driven by a socket wrench or a ratchet wrench and have various sizes for fasteners of different sizes. To permit easy recognition of the size of a wrench socket by a user, the manufacturer generally mark the size of the wrench socket on the outer periphery of the wrench socket by printing or pressing.

U.S. Pat. No. 8,074,539 discloses a socket having an outer periphery around which a sleeve is mounted. The sleeve includes a surface having an indication portion formed by laser printing for indicating the size of the socket. However, the indication portion is not always in a position facing the user. Thus, the user has to rotate the socket to find the indication portion for reading the size of the socket, which is inconvenient during operation. Furthermore, it is difficult to form the size indicia on the round outer periphery of the wrench socket by laser printing. Although the sleeve is provided, it is still not easy to form the size indicia on the round surface of the sleeve by laser printing. Furthermore, the size indicia formed on the surface of the sleeve by laser printing reflects light easily and, thus, adversely affects the user trying to recognize the size of the socket.

Thus, a need exists for a novel wrench socket with easily recognizable size indicia to mitigate and/or obviate the above disadvantages.

### BRIEF SUMMARY

This need and other problems in the field of easy recognition of the sizes of wrench sockets are solved by a wrench socket including first and second ends spaced from each other along a rotational axis. The wrench socket is adapted to be driven to rotate about the rotational axis for driving a fastener. An operative portion is formed on the first end of the wrench socket and includes a polygonal hole defined in the first end of the wrench socket and extending along the rotational axis. A driving portion is formed on the second end of the wrench socket and includes an inner driving portion defined in the second end of the wrench socket and extending along the rotational axis. The driving portion further includes an outer driving portion on an outer periphery of the second end of the wrench socket. The outer driving portion includes six abutment faces arranged in a circumferential direction about the rotational axis, such that the driving portion is substantially hexagonal in cross section. A first indicia is recessed in each of three of the six abutment faces not contiguous to each other. Each first indicia indicates a size of the polygonal hole.

An auxiliary mark can be recessed in at least one of the remaining three abutment faces without the first indicia. The auxiliary mark can be a trademark or a figure.

The first indicia can be a numeral having an upright orientation parallel to the rotational axis. The auxiliary mark has an upright orientation orthogonal to the rotational axis and the circumferential direction.

A second indicia can be recessed in at least one of the remaining three abutment faces without the first indicia. The second indicia indicates the size of the polygonal hole.

In an embodiment, only one of the six abutment faces includes the second indicia, and two of the six abutment faces include the auxiliary mark.

An engagement notch can be defined in each two adjacent abutment faces of the driving portion. Each engagement notch extends in the circumferential direction.

The polygonal hole can be hexagonal, dodecagonal, or a hole with a plurality of lobes. Each engagement notch can be substantially V-shaped.

A rounded corner can be formed between each two adjacent abutment faces of the driving portion. Each engagement notch is formed in one of the rounded corners.

The inner driving portion can include an inner wall face parallel to one of the six abutment faces of the outer driving portion.

The inner driving portion can be a hole having rectangular cross sections and having four inner wall faces. A positioning groove is defined in at least one of the four inner wall faces.

When the wrench socket is coupled with a socket wrench, a driving column of the socket wrench is engaged in the inner driving portion, and a ball of the driving column is engaged in the positioning groove.

When the wrench socket is coupled with a ratchet wrench, the driving portion is engaged in a ratchet wheel of the ratchet wrench, the six abutment faces contact an inner periphery of the ratchet wheel, and the engagement notches engage with a retaining ring of the ratchet wrench.

In another aspect, the present invention provides a wrench socket set including three wrench sockets. Each of the three wrench sockets is adapted to be driven to rotate about a rotational axis for driving a fastener. Each of the three wrench sockets includes an operative portion and a driving portion spaced from the operative portion along the rotational axis. The operative portion includes a polygonal hole extending along the rotational axis. The driving portion includes a recessed inner driving portion extending along the rotational axis. The driving portion further includes six abutment faces on an outer periphery thereof. The six abutment faces are arranged in a circumferential direction about the rotational axis, such that the driving portion is substantially hexagonal in cross section. An engagement notch is defined in each two adjacent abutment faces of the driving portion. Each engagement notch is substantially V-shaped and extends in the circumferential direction. Each of the three wrench sockets includes a first indicia recessed in each of three of the six abutment faces not contiguous to each other. The first indicia of each of the three wrench sockets indicates a size of the corresponding polygonal hole. The first indicias of the three wrench sockets indicate different sizes.

The operative portion of each of the three wrench sockets can include an outer periphery surrounding the polygonal hole. The outer periphery of the operative portion of each of the three wrench sockets is substantially cylindrical. The outer peripheries of the operative portions of the three wrench sockets define different outer diameters. The six abutment faces of each of the three wrench sockets include three pairs of opposite abutment faces. Each of the three pairs of opposite abutment faces have an identical spacing therebetween.

Illustrative embodiments will become clearer in light of the following detailed description described in connection with the drawings.

### DESCRIPTION OF THE DRAWINGS

The illustrative embodiments may best be described by reference to the accompanying drawings where:

FIG. 1 is a perspective view of a multifunction wrench socket with easily recognizable size indicia of a first embodiment according to the present invention.

FIG. 2 is another perspective view of the multifunction wrench socket of FIG. 1.

FIG. 3 is a side elevational view of the multifunction wrench socket of FIG. 1.

FIG. 4 is a right side view of the multifunction wrench socket of FIG. 3.

FIG. 5 is a cross sectional view taken along section line 5-5 of FIG. 3.

FIG. 6 is a cross sectional view taken along section line 6-6 of FIG. 3.

FIG. 7 is a perspective view of a socket wrench and the multifunction wrench socket of FIG. 1.

FIG. 8 is a perspective view of a ratchet wrench and the multifunction wrench socket of FIG. 1.

FIG. 9 is a side elevational view of a multifunction wrench socket with easily recognizable size indicia of a second embodiment according to the present invention.

FIG. 10 is a rear side view of the multifunction wrench socket of FIG. 9.

FIG. 11 is a perspective view of a toolbox receiving a set of multifunction wrench sockets with easily recognizable size indicia according to the present invention.

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood. Further, the exact dimensions and dimensional proportions to conform to specific force, weight, strength, and similar requirements will likewise be within the skill of the art after the following teachings have been read and understood.

Where used in the various figures of the drawings, the same numerals designate the same or similar parts. Furthermore, when the terms “first”, “second”, “side”, “end”, “portion”, “spacing”, and similar terms are used herein, it should be understood that these terms have reference only to the structure shown in the drawings as it would appear to a person viewing the drawings and are utilized only to facilitate describing the illustrative embodiments.

### DETAILED DESCRIPTION

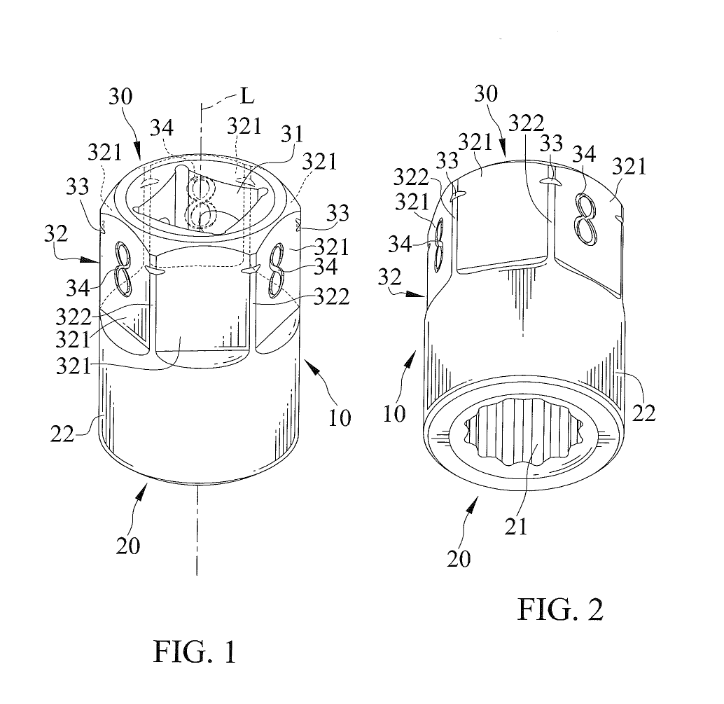

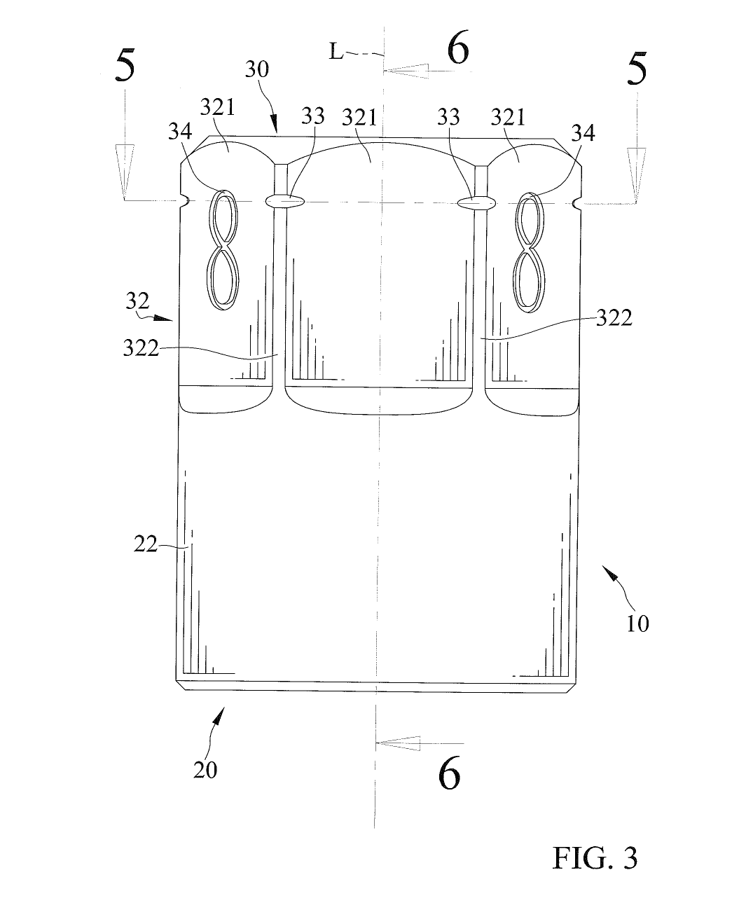

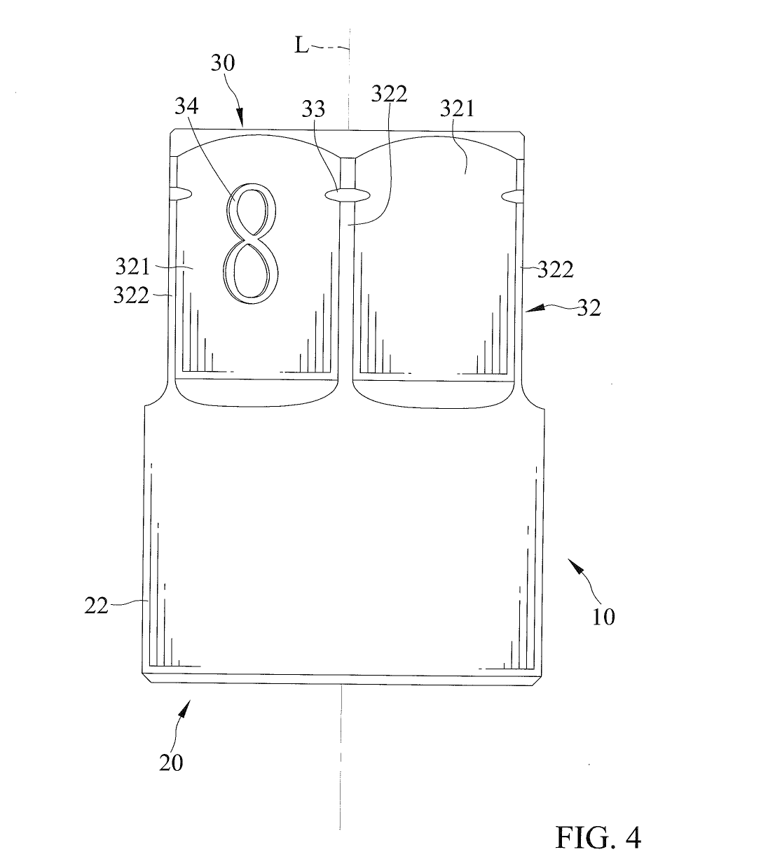

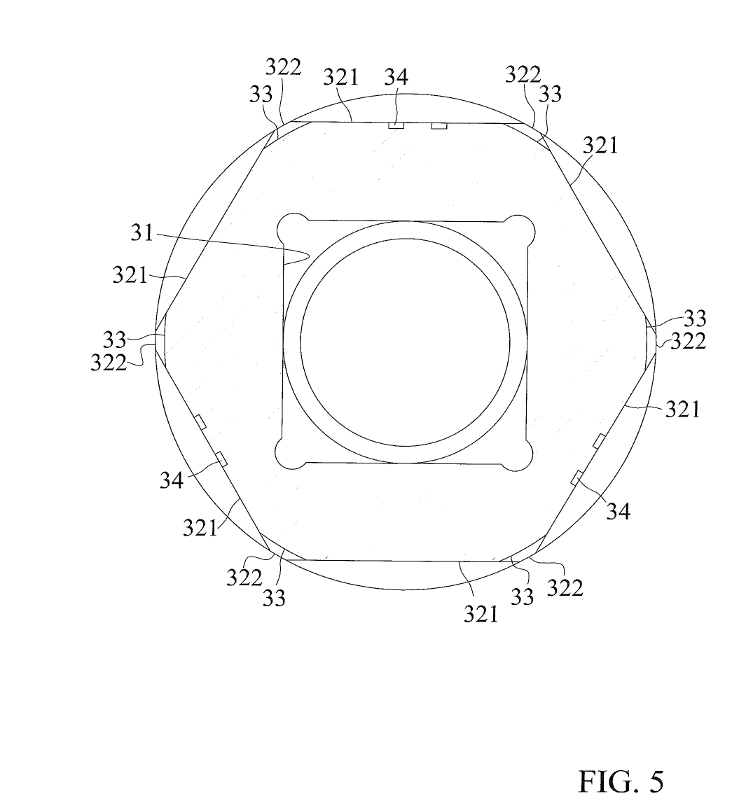

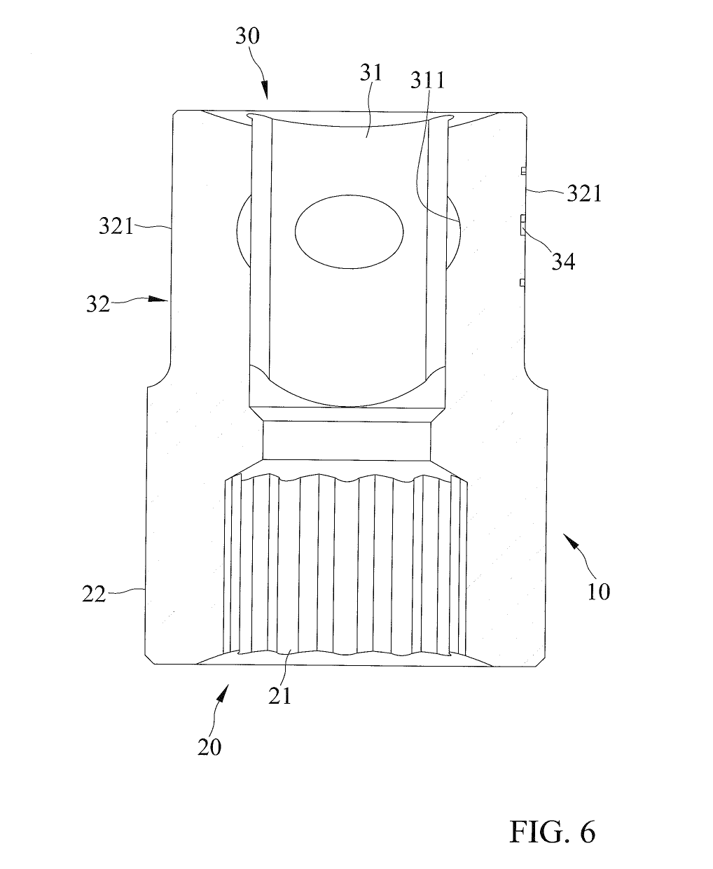

FIGS. 1-6 show a wrench socket 10 of a first embodiment according to the present invention. The wrench socket 10 is a multifunction wrench socket with an easily recognizable size indicia. The wrench socket 10 includes first and second ends spaced from each other along a rotational axis L. The wrench socket 10 is adapted to be driven to rotate about the rotational axis L for driving a fastener.

An operative portion 20 is formed on the first end of the wrench socket 10. The operative portion 20 includes a polygonal hole 21 defined in the first end of the wrench socket 10 and extending along the rotational axis L. The polygonal hole 21 can be hexagonal, dodecagonal, or a hole with a plurality of lobes. In this embodiment, the polygonal hole 21 is a hole with a plurality of lobes. The operative portion 20 includes an outer periphery 22 surrounding the polygonal hole 21. The outer periphery 22 of the operative portion 20 is substantially cylindrical.

A driving portion 30 is formed on the second end of the wrench socket 10. The driving portion 30 includes an inner driving portion 31 defined in the second end of the wrench socket 10 and extending along the rotational axis L. In this embodiment, the inner driving portion 31 is a hole having rectangular cross sections and having four inner wall faces. A positioning groove 311 is defined in at least one of the four inner wall faces and is substantially semi-circular in cross section. The driving portion 30 further includes an outer driving portion 32 on an outer periphery of the second end of the wrench socket 10. The outer driving portion 32 includes six abutment faces 321 arranged in a circumferential direction about the rotational axis L, such that the driving portion 30 is substantially hexagonal in cross section. One of the four inner wall faces of the inner driving portion 31 is parallel to one of the six abutment faces 321 of the outer driving portion 32. A rounded corner 322 is formed between each two adjacent abutment faces 321 of the driving portion 30.

An engagement notch 33 is defined in each two adjacent abutment faces 321 of the driving portion 30. Each engagement notch 33 is formed in one of the rounded corners 322. In this embodiment, each engagement notch 33 is substantially V-shaped and extends in the circumferential direction.

A first indicia 34 is recessed in each of three of the six abutment faces 321 not contiguous to each other includes. The first indicia 34 indicates the size of the polygonal hole 21. The first indicia 34 is a numeral having an upright orientation parallel to the rotational axis L.

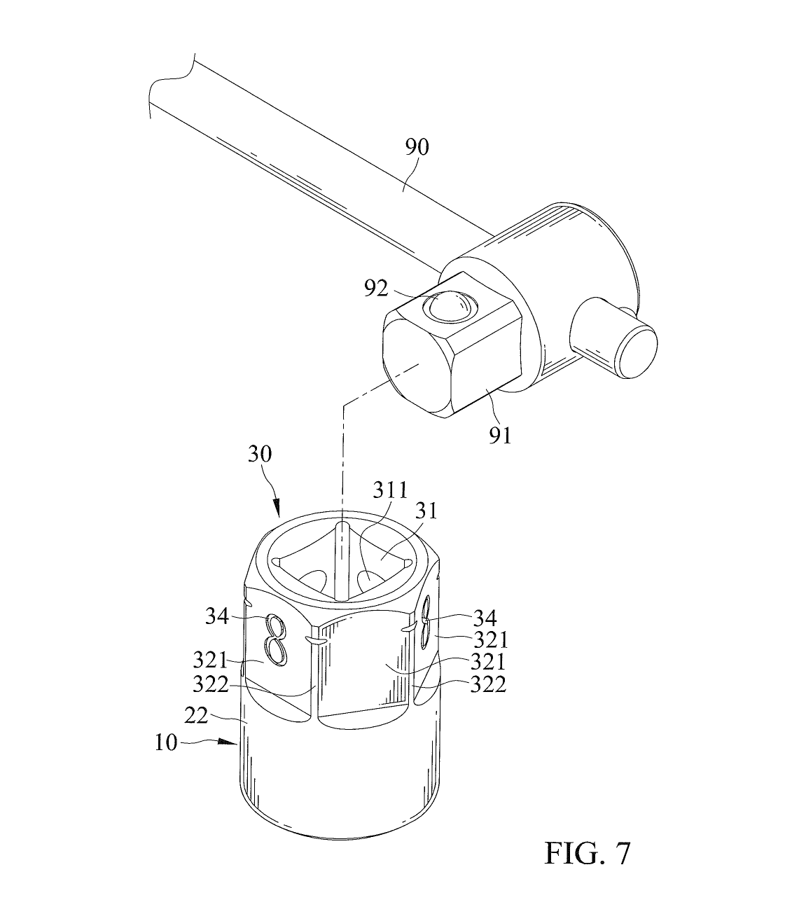

With reference to FIG. 7, when the wrench socket 10 is coupled with a socket wrench 90, a driving column 91 of the socket wrench 90 is engaged in the inner driving portion 31, such that the socket wrench 90 can drive the wrench socket 10 to rotate. Furthermore, a ball 92 of the driving column 91 is engaged in the positioning groove 311 to prevent disengagement of the wrench socket 10.

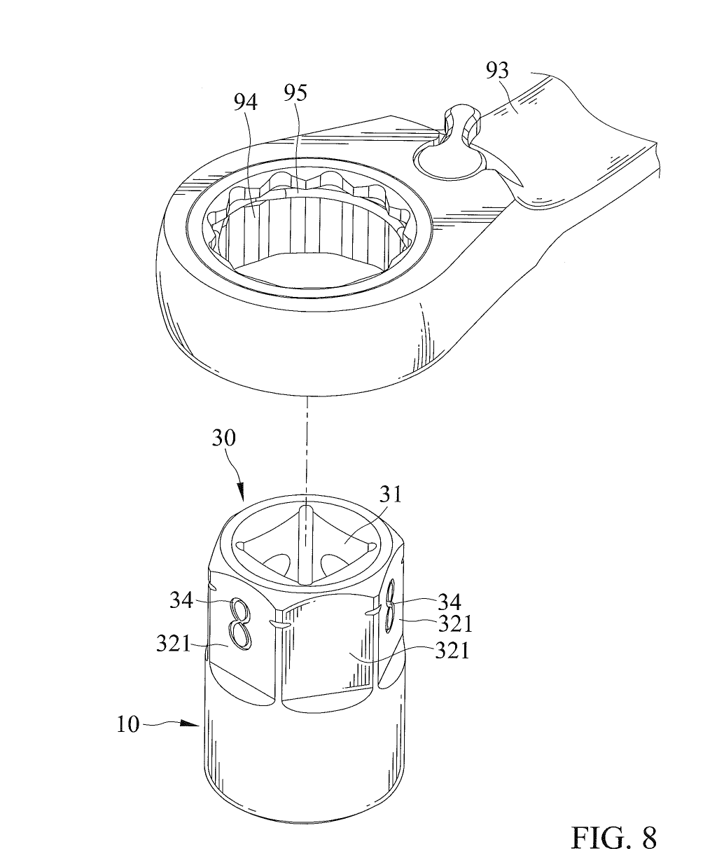

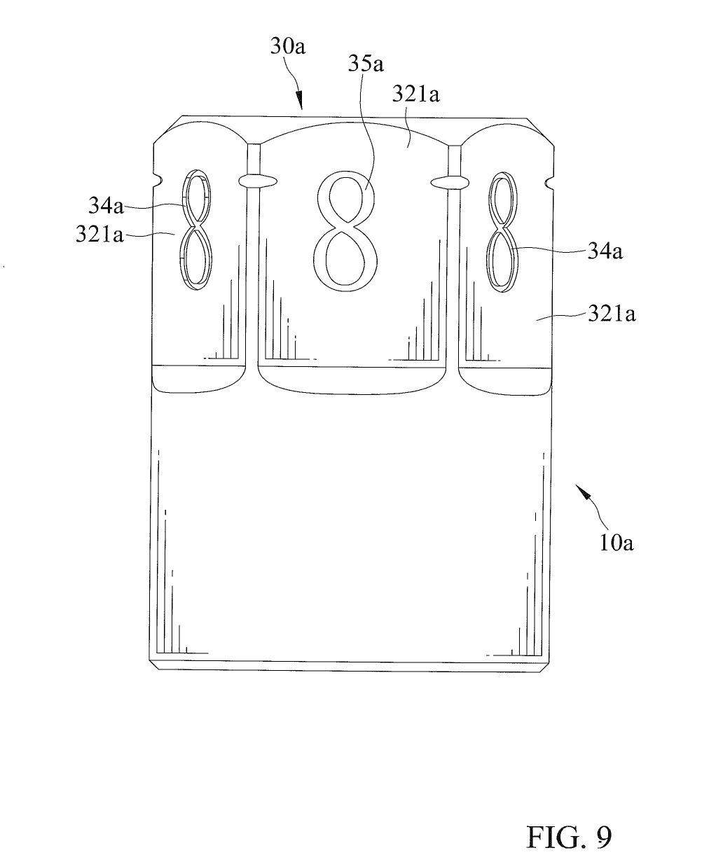

With reference to FIG. 8, when the wrench socket 10 is coupled with a ratchet wrench 93, the driving portion 30 is engaged in a ratchet wheel 94 of the ratchet wrench 93, and the six abutment faces 321 contact an inner periphery of the ratchet wheel 94. Thus, the ratchet wrench 93 can drive the wrench socket 10 to rotate. Furthermore, the engagement notches 33 engage with a retaining ring 95 of the ratchet wrench 93 to prevent disengagement of the wrench socket 10.

The first indicia 34 is formed in a plane area of the wrench socket 10 to permit easy processing. Furthermore, reflection of light is less easily to occur at the first indicia 34 of the wrench socket 10, such that a user can easily recognize the first indicia 34. Furthermore, there are three first indicias 34 (namely, the angle between two adjacent first indicias 34 is 120°), such that the user can clearly see at least one of the three first indicias 34 from any visual angle. Thus, the user can rapidly see the size of the wrench socket 10 and pick the wrench socket 10 of the desired size without rotating the wrench socket 10.

The driving portion 30 of the wrench socket 10 permits rapid recognition of the size and can be coupled with different types of wrenches (such as the socket wrench 90 and the ratchet wrench 93) while providing a disengagement prevention effect by the engagement notches 33. Thus, the wrench socket 10 is a multifunction socket tool permitting easy recognition and providing wide applications.

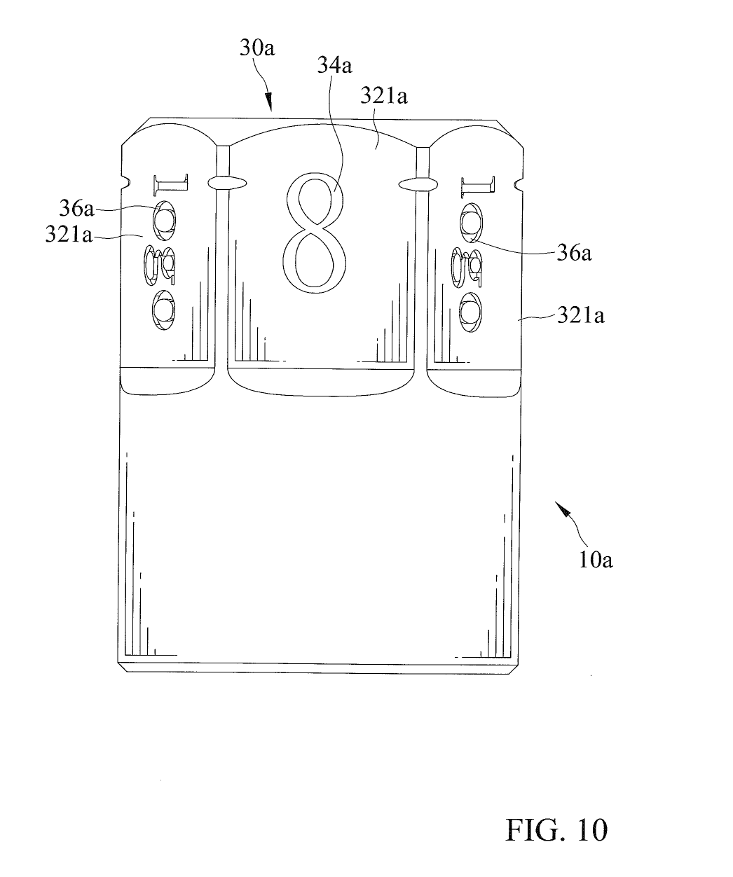

FIGS. 9 and 10 show a wrench socket of a second embodiment according to the present invention. The second embodiment is substantially the same as the first embodiment except that a second indicia 35a is recessed in at least one of the remaining three abutment faces 321a of the wrench socket 10a without the first indicia 34a. The second indicia 35a also indicates the size of the polygonal hole 21. In this embodiment, only one of the six abutment faces 321 includes the second indicia 35a.

Furthermore, in the second embodiment, an auxiliary mark 36a is recessed in at least one of the remaining abutment faces 321a without the first indicia 34a and the second indicia 35a. The auxiliary mark 36a is a trademark or a figure. The auxiliary mark 36a has an upright orientation orthogonal to the rotational axis L and the circumferential direction. In this embodiment, two of the six abutment faces 321a include the auxiliary mark 36a.

The number or the type of the second indicia 35 and the auxiliary mark 36a can be varied according to different needs.

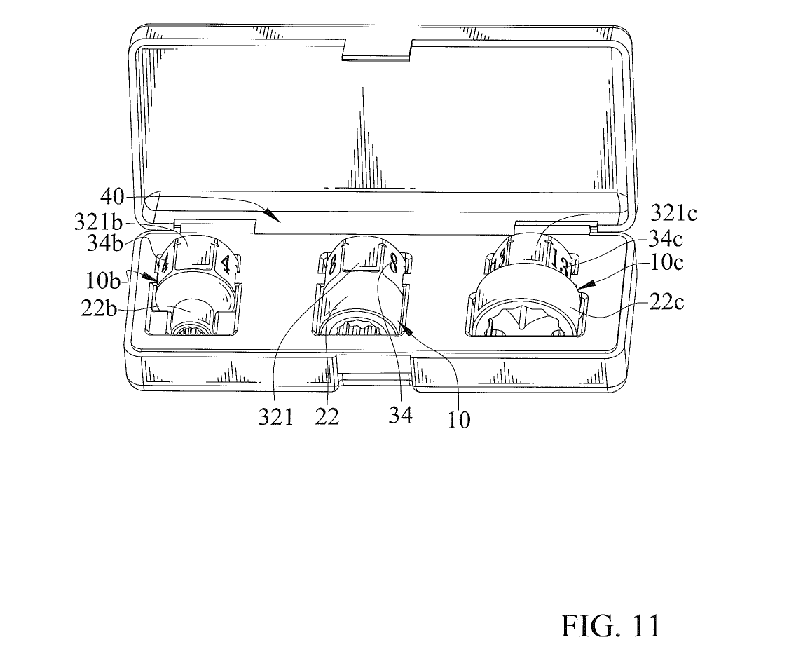

FIG. 11 shows a wrench socket set 40. The wrench socket set 40 includes three wrench sockets 10, 10b, and 10c. The wrench sockets 10b and 10c are substantially the same as the wrench socket 10. The six abutment faces 321, 321b, 321c of each wrench socket 10. 10b. 10c includes three pairs of opposite abutment faces 321, 321b, 321c. Each of the three pairs of opposite abutment faces 321 of the wrench socket 10 has an identical spacing therebetween. Each of the three pairs of opposite abutment faces 321b of the wrench socket 10b has an identical spacing therebetween. Each of the three pairs of opposite abutment faces 321c of the wrench socket 10c has an identical spacing therebetween. The first indicias 34, 34b, and 34c of the three wrench sockets 10, 10b, and 10c indicate different sizes. In this embodiment, the size of the polygonal hole 21 indicated by first indicia 34 of the wrench socket 10 is 8 mm. The size of the polygonal hole 21 indicated by first indicia 34b of the wrench socket 10 is 4 mm. The size of the polygonal hole 21 indicated by first indicia 34c of the wrench socket 10c is 13 mm. The outer diameter of the outer periphery 22 of the wrench socket 10, the outer diameter of the outer periphery 22b of the wrench socket 10b, and the outer diameter of the outer periphery 22c of the wrench socket 10c are different from each other.

In view of the foregoing, the first indicia 34, 34a, 34b, 34c of the wrench socket 10, 10a, 10b, 10c is formed in a plane area of the wrench socket 10, 10a, 10b, 10c to permit easy processing. Furthermore, reflection of light is less easily to occur at the first indicia 34, 34a, 34b, 34c of the wrench socket 10, 10a, 10b, 10c, such that the user can easily recognize the first indicia 34, 34a, 34b, 34c. Furthermore, the user can clearly see at least one of the three first indicias 34, 34a, 34b, 34c from any visual angle and can pick the wrench socket 10, 10a, 10b, 10c of the desired size without rotating the wrench socket 10, 10a, 10b, 10c. Furthermore, the driving portion 30 of the wrench socket 10, 10a, 10b, 10c permits rapid recognition of the size and can be coupled with different types of wrenches (such as the socket wrench 90 and the ratchet wrench 93) while providing a disengagement prevention effect by the engagement notches 33.

Thus since the illustrative embodiments disclosed herein may be embodied in other specific forms without departing from the spirit or general characteristics thereof, some of which forms have been indicated, the embodiments described herein are to be considered in all respects illustrative and not restrictive. The scope is to be indicated by the appended claims, rather than by the foregoing description, and all changes which come within the meaning and range of equivalency of the claims are intended to be embraced therein.

1. A wrench socket comprising:
first and second ends spaced from each other along a rotational axis, with the wrench socket adapted to be driven to rotate about the rotational axis for driving a fastener;
an operative portion formed on the first end of the wrench socket, with the operative portion including a polygonal hole defined in the first end of the wrench socket and extending along the rotational axis; and
a driving portion formed on the second end of the wrench socket, with the driving portion including an inner driving portion defined in the second end of the wrench socket and extending along the rotational axis, with the driving portion further including an outer driving portion on an outer periphery of the second end of the wrench socket, with the outer driving portion including six abutment faces arranged in a circumferential direction about the rotational axis, such that the driving portion is substantially hexagonal in cross section,
wherein a first indicia is recessed in each of three of the six abutment faces not contiguous to each other, and each first indicia indicates a size of the polygonal hole.

2. The wrench socket as claimed in claim 1, wherein an auxiliary mark is recessed in at least one of remaining three abutment faces without the first indicia, and the auxiliary mark is a trademark or a figure.

3. The wrench socket as claimed in claim 2, wherein the first indicia is a numeral having an upright orientation parallel to the rotational axis, and the auxiliary mark has an upright orientation orthogonal to the rotational axis and the circumferential direction.

4. The wrench socket as claimed in claim 1, wherein a second indicia is recessed in at least one of remaining three abutment faces without the first indicia, and the second indicia indicates the size of the polygonal hole.

5. The wrench socket as claimed in claim 4, with the first indicia being a numeral having an upright orientation parallel to the rotational axis, with an auxiliary mark recessed in at least one of the six abutment faces without the first indicia and the second indicia, with the auxiliary mark being a trademark or a figure, and with the auxiliary mark having an upright orientation orthogonal to the rotational axis and the circumferential direction.

6. The wrench socket as claimed in claim 5, wherein only one of the six abutment faces includes the second indicia, and two of the six abutment faces include the auxiliary mark.

7. The wrench socket as claimed in claim 1, wherein an engagement notch is defined in each two adjacent abutment faces of the driving portion and extends in the circumferential direction.

8. The wrench socket as claimed in claim 7, wherein the polygonal hole is hexagonal, dodecagonal, or a hole with a plurality of lobes, and each engagement notch is substantially V-shaped.

9. The wrench socket as claimed in claim 7, wherein a rounded corner is formed between each two adjacent abutment faces of the driving portion, and each engagement notch is formed in one of the rounded corners.

10. The wrench socket as claimed in claim 1, wherein the inner driving portion includes an inner wall face parallel to one of the six abutment faces of the outer driving portion.

11. The wrench socket as claimed in claim 7, with the inner driving portion being a hole having rectangular cross sections and having four inner wall faces, with a positioning groove defined in at least one of the four inner wall faces,
wherein when the wrench socket is coupled with a socket wrench, a driving column of the socket wrench is engaged in the inner driving portion, and a ball of the driving column is engaged in the positioning groove, and
wherein when the wrench socket is coupled with a ratchet wrench, the driving portion is engaged in a ratchet wheel of the ratchet wrench, the six abutment faces contact an inner periphery of the ratchet wheel, and the engagement notches engage with a retaining ring of the ratchet wrench.

12. A wrench socket set comprising three wrench sockets, with each of the three wrench sockets adapted to be driven to rotate about a rotational axis for driving a fastener, with each of the three wrench sockets comprising an operative portion and a driving portion spaced from the operative portion along the rotational axis, with the operative portion including a polygonal hole extending along the rotational axis, with the driving portion including a recessed inner driving portion extending along the rotational axis, with the driving portion further including six abutment faces on an outer periphery thereof, with the six abutment faces arranged in a circumferential direction about the rotational axis, such that the driving portion is substantially hexagonal in cross section, with an engagement notch defined in each two adjacent abutment faces of the driving portion, with each engagement notch being substantially V-shaped and extending in the circumferential direction,
wherein each of the three wrench sockets includes a first indicia recessed in each of three of the six abutment faces not contiguous to each other, wherein the first indicia of each of the three wrench sockets indicates a size of the corresponding polygonal hole, and wherein the first indicias of the three wrench sockets indicate different sizes.

13. The wrench socket set as claimed in claim 12, with the operative portion of each of the three wrench sockets including an outer periphery surrounding the polygonal hole, with the outer periphery of the operative portion of each of the three wrench sockets being substantially cylindrical, with the outer peripheries of the operative portions of the three wrench sockets defining different outer diameters, with the six abutment faces of each of the three wrench sockets including three pairs of opposite abutment faces, and with each of the three pairs of opposite abutment faces having an identical spacing therebetween.
